(19) United States
(12) Patent Application Publication
(10) Pub. No.: US 2011/0123708 A1
(43) Pub. Date: May 26, 2011

(54) MANUFACTURING METHOD FOR A LAMINATED BODY

(75) Inventors: Takumi Shibuta, Chiba (JP); Makiko Hara, Chiba (JP); Taiichi Sakaya, Chiba-shi (JP); Naoko Sakaya, Chiba (JP)

(73) Assignee: SUMITOMO CHEMICAL COMPANY, LIMITED, Chuo-ku, Tokyo (JP)

(21) Appl. No.: 12/919,917

(22) PCT Filed: Feb. 27, 2009
(86) PCT No.: PCT/JP2009/054234

§ 371 Date: Dec. 6, 2010

(30) Foreign Application Priority Data
Feb. 29, 2008 (JP) 2008-049506 2008

(51) Int. Cl. B05D 5/06

(52) U.S. Cl. 427/68

(57) ABSTRACT

A method for producing a layered article having a layer of particles stacked on a substrate, including the following steps: (1): preparing a mixed particle dispersion liquid by dispersing, in a liquid dispersion medium, inorganic particle chains (A) in a volume fraction of from 0.30 to 0.84, each of the chains being composed of three or more particles with a particle diameter of from 10 to 60 nm attached to each other in a chain form, inorganic particles (B) having an average particle diameter of from 1 to 20 nm in a volume fraction of from 0.10 to 0.45, and particles (C) having an average particle diameter Dc of larger than 20 nm in a volume fraction of from 0.06 to 0.25, (2): applying the mixed particle dispersion liquid onto the substrate, and (3): removing the liquid dispersion medium from the mixed particle dispersion liquid applied, thereby forming, on the substrate, the particle layer having a thickness of D that satisfies 0.5D≦Dc≦D.

### TECHNICAL FIELD

The present invention relates to a method for producing a layered article comprising a substrate and a particle layer formed thereon.

### BACKGROUND ART

In such displays as LCD, PDP, CRT, organic EL, inorganic EL, and FED, reflection of extraneous light, such as solar light or light emitted by a fluorescent lamp, which occurs on a display surface may result in the occurrence of reflection or halation to deteriorate the visibility of images.

This phenomenon is caused by the existence of a large difference between the refractive index of a part of a display located near the surface of the display and the refractive index of the atmosphere in contact with that part. As means for reducing such a refractive index difference has been known to form, on the surface of a display, an antireflective film composed of a material with a refractive index lower than that of the material constituting the surface. As a substrate with an antireflective film has been known, for example, a visible-light-antireflective film in which the surface of a glass substrate has been coated with a film with a thickness of from 110 to 250 nm composed of chain-like silica fine particles and non-particulate silica in an amount of from 5 to 30% relative to the weight of the chain-like silica fine particles and irregularities have been formed on the surface of the film (see JP 11-292568 A).

However, in order to form the antireflective film mentioned above, it is necessary to use a silicon compound selected from among organosilicon compounds which can be hydrolyzed and/or polycondensed and their hydrolysates and carry out treatment at a high temperature of several hundred degrees centigrade. Therefore, only a material with high heat resistance can be used as a substrate on which an antireflective film is to be formed. Although an antireflective layer is required to have high strength because it is disposed on the surface of a display, there is a problem that it is difficult to reconcile strength with antireflection performance because strength decreases if the refractive index of a film is reduced by forming a structure containing voids or a low density structure for improving antireflection performance.

### DISCLOSURE OF THE INVENTION

An object of the present invention is to provide a method for producing a layered article which can be formed without performing treatment at high temperatures and which excels in balance of antireflection performance and film strength.

The present invention relates to a method for producing a layered article in which a layer of particles is stacked on a substrate, the method including the following steps (1) to (3):

step (1): a step of preparing a mixed particle dispersion liquid by dispersing, in a liquid dispersion medium, inorganic particle chains (A) in a volume fraction of from 0.30 to 0.84, each of the chains being composed of three or more particles with a particle diameter of from 10 to 60 nm attached to each other in a chain form, inorganic particles (B) having an average particle diameter of 1 to 20 nm in a volume fraction of from 0.10 to 0.45, and particles (C) having an average particle diameter Dc of larger than 20 nm in a volume fraction of from 0.06 to 0.25,

step (2): a step of applying the mixed particle dispersion liquid onto the substrate, and

step (3): a step of removing the liquid dispersion medium from the mixed particle dispersion liquid applied, thereby forming, on the substrate, the particle layer having a thickness of D that satisfies 0.5D≦Dc≦D.

### MODE FOR CARRYING OUT THE INVENTION

Layered articles produced by the method of the present invention are components that are to be used mainly as antireflection members of various displays like LCD, PDP, CRT, organic EL, inorganic EL, and FED, and more specifically, components which are mounted mainly on the surface of a display or inside a display for the purpose of preventing reflection on a surface of a display caused by extraneous light or preventing decrease in the luminance of a display resulting from the reflection in the display of light emitted by a luminous element mounted inside the display.

In the present invention, the substrate may be composed of any material which has appropriate mechanical stiffness depending upon the application of a layered article to produce, and film, sheet, foil, and so on made of resin, glass, metal, or an inorganic substance can be used. Although the substrate is preferably one having a smooth surface, it may be one having irregularities, one having a circuit pattern, a decorative pattern, or the like on the surface, or a porous film. When a layered article produced is used for a display material, the use of a transparent material, e.g., film or sheet of a transparent plastic or transparent glass sheet is preferred. Specific examples of the transparent plastic film or sheet include films or sheets made of polyethylene terephthalate, polyethylene, polypropylene, cellophane, triacetylcellulose, diacetylcellulose, acetylcellulose butyrate, polymethyl methacrylate, and so on. Film or sheet made of triacetyl cellulose or polyethylene terephthalate is preferred because they are highly transparent and free of anisotropy. Such optical components as a polarizing plate, a diffuser plate, a light guide plate, a luminance enhancing film, and a reflective polarizing plate can also be used as the substrate. The substrate may have a hard coat layer made of an ultraviolet curable resin, or the like or an antistatic layer containing conductive particles, or the like as a surface layer.

The mixed particle dispersion liquid is a product prepared by dispersing, in a liquid dispersion medium, inorganic particle chains (A) in a volume fraction of from 0.30 to 0.84, each of the chains being composed of three or more particles with a particle diameter of from 10 to 60 nm attached to each other in a chain form, inorganic particles (B) having an average particle diameter of 1 to 20 nm in a volume fraction of from 0.10 to 0.45, and particles (C) having an average particle diameter Dc of larger than 20 nm in a volume fraction of from 0.06 to 0.25.

The chemical composition of the inorganic particle chains (A) may be either the same as or different from the chemical composition of the inorganic particles (B). Examples of inorganic particles which are used as the inorganic particle chains (A) or the inorganic particles (B) include silicon oxide (i.e., silica), titanium oxide, aluminum oxide, zinc oxide, tin oxide, calcium carbonate, barium sulfate, talc, and kaolin. The inorganic particle chains (A) and the inorganic particles (B) are preferably composed of silica particles because silica particles are high in dispersibility in a solvent, low in refractive index, and easy to obtain a powder small in particle size distribution.

The particles (C) of the present invention may be either inorganic particles or resin particles. Moreover, the chemical composition thereof may be either the same as of different from the chemical composition of the inorganic particle chains (A) or the inorganic particles (B). Examples of the inorganic particles include particles of metal oxides, such as silicon oxide (silica), titanium oxide, aluminum oxide, zinc oxide, tin oxide, calcium carbonate, and barium sulfate, particles of minerals, such as talc and kaolin, and particles of metals, such as platinum, gold, silver, copper, aluminum, nickel, tantalum, and tungsten. Examples of the resin particles include particles made of acrylic resin, styrene-based resin, polyethylene-based resin, PAN, nylon, polyurethane-based resin, phenol-based resin, silicone-based resin, benzoguanamine-based resin, melamine-based resin, or fluororesin. The particle chains (C) are preferably composed of silica particles because silica particles are high in dispersibility in a solvent, low in refractive index, and easy to obtain a powder small in particle size distribution.

The inorganic particle chains (A) to be used for the method of the present invention are chains each composed of three or more inorganic particles with a particle diameter within the range of from 10 to 60 nm, preferably within the range of from 20 to 50 nm, linked in a chain form. The particle diameter of the particles forming the inorganic particle chains (A) is a particle diameter determined from an image observed by using an optical microscope, a laser microscope, a scanning electron microscope, a transmission electron microscope, an atomic force microscope, or the like, an average particle diameter determined by a BET method, or an average particle diameter determined by a Sears method. The Sears method, which is disclosed in Analytical Chemistry, Vol. 28, p. 1981-1983, 1956, is an analytical method to be applied to the measurement of the average particle diameter of silica particles; it is a method in which the surface area of silica particles is determined from the amount of NaOH to be consumed for making a colloidal silica dispersion liquid from pH=3 to pH=9 and then a sphere equivalent diameter is calculated from the determined surface area. As such inorganic particle chains can be used commercially available products, examples of which include SNOWTEX (registered trademark) UP, OUP, PS-S, PS-SO, PS-M, and PS-MO produced by Nissan Chemical Industries, Ltd., which are silica sols containing water as a dispersion medium, and IPA-ST-UP produced by Nissan Chemical Industries, Ltd., which is silica sol containing isopropanol as a dispersion medium. The particle diameter of the particles forming inorganic particle chains and the shape of the inorganic particle chains can be determined through observation using a transmission electron microscope. The expression “attached to each other in a chain form” as used herein is an expression opposite to “attached to each other in a circular form” and encompasses not only particles linked in a straight form but also particles linked in a bent form.

The average particle diameter of the inorganic particles (B) to be used for the method of the present invention is within the range of from 1 to 20 nm, and preferably is from 1 to 10 nm. The average particle diameter of the inorganic particles (B) is a particle diameter determined from an image observed by using a scanning electron microscope, a transmission electron microscope, an atomic force microscope, or the like or an average particle diameter determined by a dynamic light scattering method, a Sears method, or the like.

The average particle diameter Dc of the particles (C) to be used for the method of the present invention is larger than 20 nm, and preferably is from 60 to 200 nm. The average particle diameter of the particles (C) is a particle diameter observed in an image by using an optical microscope, a laser microscope, a scanning electron microscope, a transmission electron microscope, an atomic force microscope, or the like, an average particle diameter determined by a laser diffraction scattering method, a dynamic light scattering method, a BET method, or an average particle diameter determined by a Sears method.

The thickness of the layered article formed by the method of the present invention satisfies 0.5D≦Dc≦D. If Dc<0.5D, an effect of increasing the strength of a particle layer cannot be obtained. It is undesirable that D<Dc because if so, surface smoothness is lost.

The liquid dispersion medium of the present invention may be any one having a function to disperse particles; for example, water, methanol, n-butanol, isopropanol, ethylene glycol, n-propyl cellosolve, dimethylacetamide, methyl ethyl ketone, methyl isobutyl ketone, xylene, propylene glycol monomethyl acetate, and propylene glycol monomethyl ether can be used, and water is preferred because it is easy to handle. In order to improve the dispersibility of the inorganic particle chains (A), the inorganic particles (B), and the particles (C) in the aforementioned solvent, the particles may be surface-treated and a dispersion medium electrolyte or a dispersion aid may be added.

The mixed particle dispersion liquid may be prepared by dispersing the inorganic particle chains (A), the inorganic particles (B), and the particles (C) in a liquid dispersion medium by an appropriate method and can be prepared typically by any of the following methods [1] to [5], but the method for the preparation of the mixed particle dispersion liquid is not restricted to these methods.

[1] A method in which a powder of inorganic particle chains (A), a powder of inorganic particle (B), and a powder of particles (C) are added simultaneously to a common liquid dispersion medium and then dispersed.

[2] A method in which a first dispersion liquid is prepared by dispersing inorganic particle chains (A) in a first liquid dispersion medium, a second dispersion liquid is prepared by dispersing inorganic particles (B) in a second liquid dispersion medium, a third dispersion liquid is prepared by dispersing particles (C) in a third liquid dispersion medium, and then the first, second, and third dispersion liquids are mixed.

[3] A method in which a dispersion liquid is prepared by dispersing inorganic particle chains (A) in a liquid dispersion medium, add then a powder of inorganic particles (B) and a powder of particles (C) are added and dispersed.

[4] A method in which a dispersion liquid is prepared by dispersing inorganic particles (B) in a liquid dispersion medium, add then a powder of inorganic particle chains (A) and a powder of particles (C) are added and dispersed.

[5] A method in which a first dispersion liquid containing inorganic particle chains (A) by growing particles in a dispersion medium, a second dispersion liquid containing inorganic particles (B) is prepared by growing particles in a dispersion medium, a third dispersion liquid is prepared by growing particles in a dispersion medium, and then mixing the first, second and third dispersion liquids.

By applying strong dispersion means, such as ultrasonic dispersion and ultrahigh pressure dispersion, it is possible to disperse particles particularly uniformly in a mixed particle dispersion liquid.

In order to achieve dispersion with higher uniformity, it is desirable that the dispersion liquid of inorganic particle chains (A), the dispersion liquid of inorganic particles (B) and the dispersion liquid of particles (C) to be used for the preparation of a mixed particle dispersion liquid be in a colloidal state and it is desirable that particles be in a colloidal state in a mixed particle dispersion liquid to be obtained finally.

In the aforementioned method [2], [3], [4], or [5], when the dispersion liquid of the inorganic particle chains (A), the dispersion liquid of the inorganic particles (B), or the dispersion liquid of the particles (C) is colloidal alumina, it is desirable to add an anion, such as chlorine ion, sulfate ion, and acetate ion, as a counter anion, to the colloidal alumina in order to stabilize alumina particles to be positively charged. Although the colloidal alumina is not particularly limited with respect to pH, it preferably has a pH of from 2 to 6 from the viewpoint of the stability of a dispersion liquid.

Moreover, also in the aforementioned method [1], when at least one of the inorganic particle chains (A), the inorganic particles (B), and the particles (C) is alumina and the mixed particle dispersion liquid is in a colloidal state, it is desirable to add an anion, such as chlorine ion, sulfate ion, and acetate ion, to the mixed particle dispersion liquid.

In the aforementioned method [2], [3], [4], or [5], when the dispersion liquid of the inorganic particle chains (A), the dispersion liquid of the inorganic particles (B), or the dispersion liquid of the particles (C) is colloidal silica, it is desirable to add a cation, such as ammonium ion, alkali metal ion, and alkaline earth metal ion, as a counter cation, to the colloidal silica in order to stabilize silica particles to be negatively charged. Although the colloidal silica is not particularly limited with respect to pH, it preferably has a pH of from 8 to 11 from the viewpoint of the stability of a dispersion liquid.

Moreover, also in the aforementioned method [1], when at least one of the inorganic particle chains (A), the inorganic particles (B), and the particles (C) is silica and the mixed particle dispersion liquid is in a colloidal state, it is desirable to add a cation, such as ammonium ion, alkali metal ion, and alkaline earth metal ion, to the mixed particle dispersion liquid.

From the viewpoint of maintaining the balance between antireflection performance and film strength, it is preferable with the dispersion liquid of the present invention that the volume fraction of the inorganic particle chains (A) be within the range of from 0.40 to 0.56, the volume fraction of the inorganic particles (B) be within the range of from 0.35 to 0.40, and the volume fraction of the particles (C) be within the range of from 0.90 to 0.20. Although the amount of the inorganic particle chains (A), the inorganic particles (B) and the particles (C) contained in the mixed particle dispersion liquid is not particularly limited, it is desirably from 1 to 20% by weight and more preferably from 3 to 10% by weight from the viewpoint of application property and dispersibility.

Regarding the mixed particle dispersion liquid, it is desirable that in a particle size distribution curve of frequency versus particle diameter produced by measuring the dispersion liquid by a laser diffraction scattering method, a particle diameter represented by the highest peak Ra be within the range of from 0.01 to 1 and in a cumulative particle size distribution curve produced by measuring the dispersion liquid by a laser diffraction scattering method, the particle diameter D90, at which the cumulative number of particles having particle diameters of D90 or less reaches 90% of the number of all particles, be 1 μm or less. The highest peak Ra is a peak with the maximum height in the particle size distribution curve. From the viewpoint of the uniformity of a coat film to be formed, the particle diameter represented by the highest peak Ra of the mixed particle dispersion liquid (A) is preferably within the range of from 0.05 to 0.5 μm. Such a dispersion liquid can be prepared, for example, by mixing chain-shaped colloidal silica with an average particle diameter of from 10 to 25 nm as the inorganic particle chains (A), colloidal silica with an average particle diameter of 4 to 6 nm as the inorganic particles (B), and colloidal silica with an average particle diameter of 70 to 80 nm as the particles (C).

In a preferable embodiment of the present invention, a coagulant is added to a mixed particle dispersion liquid in order to improve antireflection effect and a dispersion liquid in which at least some of the particles contained in the mixed particle dispersion liquid have been coagulated is used. Although the coagulant is added typically after the preparation of a mixed particle dispersion liquid, it may have been added to a dispersion medium to be used in the preparation of a mixed particle dispersion liquid.

The coagulant is a substance that has an effect of coagulating particles that have been dispersed in a liquid medium. When a mixed particle dispersion liquid is in a colloidal state, particles are coagulated by the addition of an electrolyte. Examples of the electrolyte include citric acid salts, tartaric acid salts, sulfuric acid salts, acetic acid salts, chlorides, bromides, nitric acid salts, iodides, thiocyanic acid salts, sodium carboxymethylcellulose, and sodium alginate. Polymer coagulants composed of non-ionic polymers, such as polyvinyl alcohol and methylcellulose, or polymers obtained by polymerizing such monomers as acrylic acid, acrylamide, sodium acrylate, and dimethylaminoethyl methacrylate, which have an action of coagulating particles may also be used. When the inorganic particles in the dispersion liquid can be coagulated by adjusting the pH by adding an acid or a base, such an acid or base also corresponds to a coagulant.

When the mixed particle dispersion liquid is a hydrophilic colloid, the particles can be coagulated by using a dehydrator or using a dehydrator and an electrolyte in combination as a coagulant. The dehydrator is an agent having an effect of removing hydrated water from the surface of particles in a hydrophilic colloid, and alcohols, such as methanol, ethanol, propyl alcohol, and isopropanol, are preferred.

Regarding the dispersion liquid obtained by adding the coagulant to the mixed particle dispersion liquid in step (1) of the present invention, it is desirable that in a particle size distribution curve of frequency versus particle diameter produced by measuring the liquid by a laser diffraction scattering method, there be a peak Rb which indicates a particle diameter equal to or larger than 20 times the particle diameter represented by the highest peak Ra. The use of such a dispersion liquid makes it possible to obtain an antireflection performance. It is desirable that the dispersion liquid be a dispersion liquid such that in its particle size distribution curve there is a peak Rb which indicates a particle diameter equal to or larger than 50 times, more desirably 100 times the particle diameter represented by the highest peak Ra.

Regarding the dispersion liquid, it is desirable that in a particle size distribution curve of frequency versus particle diameter produced by measuring the liquid by a laser diffraction scattering method, the sum total of the volume of coagulated particles having particle diameters equal to or larger than 20 times the particle diameter represented by the highest peak Ra is 1% or more, desirably 5% or more of the total volume of the particles in the dispersion liquid. The use of such a dispersion liquid makes it possible to obtain an antireflection performance. Such a dispersion liquid can be prepared, for example, by preparing a dispersion liquid containing 30% by weight of isopropyl alcohol in a dispersion liquid obtained by mixing chain-like colloidal silica with an average particle diameter of from 10 to 25 nm as the inorganic particle chains (A), colloidal silica with an average particle diameter of from 4 to 6 nm as the inorganic particles (B), and colloidal silica with an average particle diameter of from 70 to 80 nm as the particles (C).

In the method of the present invention, a particle layer is formed on the aforementioned substrate by applying a mixed particle dispersion liquid to a substrate, and subsequently removing a liquid dispersion medium from the applied mixed particle dispersion liquid by suitable means. Since this particle layer has an antireflecting function, an antireflective layered article is formed by the method of the present invention. The thickness of the particle layer is not particularly limited. In the production of an antireflective layered article suitable for use as a surface layer of a display in order to effectively prevent the reflection of extraneous light in the inside of the display, the thickness of the particle layer in the antireflective layered article is adjusted preferably to from 50 to 150 nm and more preferably to from 80 to 130 nm. The thickness of the particle layer can be adjusted by changing the amounts of the inorganic particle chains (A) and the inorganic particles (B) in the mixed particle dispersion liquid, the amount of the particles (C) and the applied amount of the mixed particle dispersion liquid.

In the present invention, additives, such as a surfactant and an organic electrolyte, may be added to the mixed particle dispersion liquid for the purpose of stabilization of the dispersion of particles, and so on.

When the mixed inorganic particle dispersion liquid contains a surfactant, the content thereof is usually 0.1 parts by weight or less to 100 parts by weight of the dispersion medium. The surfactant to be used is not particularly limited and examples thereof include anionic surfactants, cationic surfactants, nonionic surfactants, and ampholytic surfactants.

The anionic surfactants include alkali metal salts of carboxylic acids and specifically include sodium caprylate, potassium caprylate, sodium decanoate, sodium caproate, sodium myristate, potassium oleate, tetramethylammonium stearate, and sodium stearate. Especially, alkali metal salts of carboxylic acids with alkyl chains having from 6 to 10 carbon atoms are preferred.

Examples of the cationic surfactants include cetyltrimethylammonium chloride, dioctadecyldimethylammonium chloride, N-octadecylpyridinium bromide, and cetyltriethylphosphonium bromide.

Examples of the nonionic surfactants include sorbitan esters of fatty acids and glycerol esters of fatty acids.

The ampholytic surfactants include 2-alkyl-N-carboxymethyl-N-hydroxyethylimidazolinium betaine, lauric acid amidopropyl betaine, and the like.

When the mixed particle dispersion liquid contains an organic electrolyte, the content thereof is usually 0.01 parts by weight or less to 100 parts by weight of the liquid dispersion medium. The organic electrolyte in the present invention is an organic compound that has an ionizable ionic group (except for a surfactant). Examples thereof include sodium p-toluenesulfonate, sodium benzenesulfonate, potassium butylsulfonate, sodium phenylphosphinate, and sodium diethylphosphate. The organic electrolyte is preferably a benzenesulfonic acid derivative.

In the present invention, the method of applying the mixed particle dispersion liquid to a substrate is not particularly restricted, and the liquid can be applied by such conventional methods as gravure coating, reverse coating, brush roll coating, spray coating, kiss coating, die coating, dipping, and bar coating.

It is desirable to apply pretreatment, such as corona treatment, ozonization, plasma treatment, flame treatment, electron beam treatment, anchor coat treatment, and rinsing, to a surface of the substrate prior to the application of the mixed particle dispersion liquid to the substrate.

By removing the liquid dispersion medium from the mixed particle dispersion liquid applied to the substrate, a particle layer is formed on the substrate. The removal of the liquid dispersion medium can be executed, for example, by heating performed under normal pressure or reduced pressure. The pressure and the heating temperature to be used in the removal of the liquid dispersion medium may be chosen appropriately according to the materials to be used (that is, the inorganic particle chains (A), the inorganic particles (B), the particles (C), and the liquid dispersion medium). For example, when the dispersion medium is water, drying may be done at from 50 to 80° C., preferably at about 60° C.

By the use of the method of the present invention, it is possible to form a particle layer which is superior in strength on a substrate without carrying out treatment at high temperatures higher than 200° C. This probably is because the formed particle layer has a structure in which the inorganic particles (B) are located in the gaps of the inorganic particle chains (A) and the inorganic particle chains (A) are bound via the inorganic particles (B).

On the particle layer of an antireflective layered article formed by the method of the present invention, an antifouling layer composed of a fluorine-containing compound or the like further may be formed. For the formation of the antifoulding layer can be used the dip coating method.

Since the antireflective layered article formed by the method of the present invention possesses a porous structure, it can be used as an anticlouding coat of glasses, agricultural films, tents, and the like by relying on the water-retaining property of pores. Moreover, since it also has a performance of permeating substance because of the possession the porous structure, it can be used also as a partition of a storage battery, a fuel cell, a solar battery, and the like.

### EXAMPLES

The present invention will be described in detail below with reference to Examples, to which the present invention is not limited.

Main materials used are as follows.

### [Inorganic Particle Chains (A)]

(1) SNOWTEX (registered trademark) PS-M (chain-like colloidal silica produced by Nissan Chemical Industries, Ltd.; particle diameter of spherical particles: from 18 to 25 nm; average particle diameter determined by a dynamic light scattering method: 111 nm; solid concentration: 20% by weight). This is hereinafter referred to as “PS-M.”

(2) SNOWTEX (registered trademark) PS-S (chain-like colloidal silica produced by Nissan Chemical Industries, Ltd.; particle diameter of spherical particles: from 10 to 18 nm; average particle diameter determined by a dynamic light scattering method: 106 nm; solid concentration: 20% by weight). This is hereinafter referred to as “PS-S.”

### [Inorganic Particles (B)]

SNOWTEX (registered trademark) ST-XS (colloidal silica produced by Nissan Chemical Industries, Ltd.; average particle diameter: from 4 to 6 nm; solid concentration: 20% by weight). This is hereinafter referred to as “ST-XS.”

### [Particles (C)]

SNOWTEX (registered trademark) ST-ZL (colloidal silica produced by Nissan Chemical Industries, Ltd.; average particle diameter: 78 nm; solid concentration: 40% by weight). This is hereinafter referred to as “ST-ZL.”

The volume fractions of inorganic particle chains and inorganic particles to all particles in a mixed particle dispersion liquid in each of Examples and Comparative Example are summarized in Table 1. In all the Examples, since both inorganic particle chains (A) and inorganic particles (B) used for the formation of a particle layer were silica, the weight fractions of the inorganic particle chains (A) and the inorganic particles (B) were used as their volume fractions.

### [Substrate]

An application liquid composed of 200 g of ST-XS, 400 g of ST-ZL, and 1400 g of water was applied with a microgravure roll (manufactured by Yasui Seiki Co., Ltd., 120 meshes) to a triacetyl cellulose film (thickness: 80 μm) produced by Fuji Photo Film Co., Ltd., and then dried at 60° C. On the resulting layered article, the operations of the application of the application liquid and its drying were repeated nine times, respectively, to afford a layered article composed of a substrate and an inorganic particle layer stacked thereon.

Evaluations in Examples were carried out by the following methods.

### [Film Strength]

The surface of a film was rubbed back and forth with #0000 steelwool ten times under a load of 200 gf/cm² and the existence of scratches on the rubbed surface of the film was checked visually. When there was ten or less scratches, the film strength was judged to be high and the judgment was expressed by a symbol “o”, whereas when there were more than ten scratches, the film strength was judged to be low and the judgement was expressed by a symbol “x”.

### [Reflectance]

The relative specular reflection intensity at an incident angle of 5° was measured by using a spectrophotometer UV-3150 manufactured by Shimadzu Corporation. The minimum value among the values of the relative specular reflection intensities of respective wavelengths within the range of from 400 nm to 700 nm was defined as the minimum reflectance. In the measurement, a black tape was stuck on the rear surface of a film.

### Example 1

A mixed particle dispersion liquid was prepared by mixing and stirring 67.5 g of PS-M and 10.0 g of PS-S as the inorganic particle chains (A), 54.0 g of ST-XS as the inorganic particles (B), 6.25 g of ST-ZL as the particles (C), and 362.3 g of water. The proportions of the inorganic particle chains (A), the inorganic particles (B), and the particles (C) in the mixed particle dispersion liquid are as given Table 1. The mixed particle dispersion liquid was applied onto an inorganic layer of a substrate with a microgravure roll (produced by Yasui Seiki Co., Ltd., 230 meshes) and dried at 60° C., yielding an antireflective layer. The thickness of the resulting antireflective layer was about 120 nm.

### Example 2

A mixed particle dispersion liquid was prepared by mixing and stirring 55.0 g of PS-M and 10.0 g of PS-S as the inorganic particle chains (A), 54.0 g of ST-XS as the inorganic particles (B), 12.5 g of ST-ZL as the particles (C), and 218.5 g of water and then further mixing and stirring 150.0 g of isopropanol. The proportions of the inorganic particle chains (A), the inorganic particles (B), and the particles (C) in the mixed particle dispersion liquid are as given Table 1. The mixed particle dispersion liquid was applied onto an inorganic layer of a substrate with a microgravure roll (produced by Yasui Seiki Co., Ltd., 230 meshes) and dried at 60° C., yielding an antireflective layer.

### Example 3

A mixed particle dispersion liquid was prepared by mixing and stirring 67.5 g of PS-M and 10.0 g of PS-S as the inorganic particle chains (A), 54.0 g of ST-XS as the inorganic particles (B), 6.25 g of ST-ZL as the particles (C), and 212.3 g of water and then further mixing and stirring 150.0 g of isopropanol. The proportions of the inorganic particle chains (A), the inorganic particles (B), and the particles (C) in the mixed particle dispersion liquid are as given Table 1. The mixed particle dispersion liquid was applied onto an inorganic layer of a substrate with a microgravure roll (produced by Yasui Seiki Co., Ltd., 230 meshes) and dried at 60° C., yielding an antireflective layer.

### Comparative Example 1

A mixed particle dispersion liquid was prepared by mixing and stirring 80.0 g of PS-M and 10.0 g of PS-S as the inorganic particle chains (A), 54.0 g of ST-XS as the inorganic particles (B), 6.75 g of ST-ZL as the particles (C), and 356.0 g of water. The proportions of the inorganic particle chains (A) and the inorganic particles (B) in the mixed particle dispersion liquid are as given Table 1. The mixed particle dispersion liquid was applied onto an inorganic layer of a substrate with a microgravure roll (produced by Yasui Seiki Co., Ltd., 230 meshes) and dried at 60° C., yielding an antireflective layer. The thickness of the resulting antireflective layer is about 120 nm.

### Comparative Example 2

A mixed particle dispersion liquid was prepared by mixing and stirring 80.0 g of PS-M and 10.0 g of PS-S as the inorganic particle chains (A), 54.0 g of ST-XS as the inorganic particles (B), and 206.0 g of water and then further mixing and stirring 150.0 g of isopropanol. The proportions of the inorganic particle chains (A) and the inorganic particles (B) in the mixed particle dispersion liquid are as given Table 1. The mixed particle dispersion liquid was applied onto an inorganic layer of a substrate with a microgravure roll (produced by Yasui Seiki Co., Ltd., 230 meshes) and dried at 60° C., yielding an antireflective layer. The thickness of the resulting antireflective layer is about 120 nm.

### Comparative Example 3

A mixed particle dispersion liquid was prepared by mixing and stirring 72.5 g of PS-M and 10.0 g of PS-S as the inorganic particle chains (A), 54.0 g of ST-XS as the inorganic particles (B), 3.75 g of ST-ZL as the particles (C), and 209.8 g of water and then further mixing and stirring 150.0 g of isopropanol. The proportions of the inorganic particle chains (A), the inorganic particles (B), and the particles (C) in the mixed particle dispersion liquid are as given Table 1. The mixed particle dispersion liquid was applied onto an inorganic layer of a substrate with a microgravure roll (produced by Yasui Seiki Co., Ltd., 230 meshes) and dried at 60° C., yielding an antireflective layer. The thickness of the resulting antireflective layer is about 120 nm.

TABLE 1

| | Volume | Volume | | | |
|---|---|---|---|---|---|
| | fraction of | fraction of | Volume | | |
| | inorganic | inorganic | fraction of | | |
| | particle | particles | particles | Film | Reflec- |
| | chains (A) | (B) | (C) | strength | tance |
| Example 1 | 0.53 | 0.38 | 0.09 | ∘ | 0.9% |
| Example 2 | 0.45 | 0.38 | 0.17 | ∘ | 0.9% |
| Example 3 | 0.53 | 0.38 | 0.09 | ∘ | 0.8% |
| Comparative | 0.62 | 0.38 | 0 | x | 1.0% |
| Example 1 | | | | | |
| Comparative | 0.62 | 0.38 | 0 | x | 0.7% |
| Example 2 | | | | | |
| Comparative | 0.57 | 0.38 | 0.05 | x | 1.0% |
| Example 3 | | | | | |

### INDUSTRIAL APPLICABILITY

According to the present invention, since high temperature treatment is not necessary, it is possible to produce a layered article in which an antireflective film with good balance of antireflection performance and film strength on a substrate formed from a thermolabile material.

1. A method for producing a layered article comprising a layer of particles stacked on a substrate, the method comprising the following steps (1) to (3):
step (1): a step of preparing a mixed particle dispersion liquid by dispersing, in a liquid dispersion medium, inorganic particle chains (A) in a volume fraction of from 0.30 to 0.84, each of the chains being composed of three or more particles with a particle diameter of from 10 to 60 nm attached to each other in a chain form, inorganic particles (B) having an average particle diameter of from 1 to 20 nm in a volume fraction of from 0.10 to 0.45, and particles (C) having an average particle diameter Dc of larger than 20 nm in a volume fraction of from 0.06 to 0.25,
step (2): a step of applying the mixed particle dispersion liquid onto the substrate, and
step (3): a step of removing the liquid dispersion medium from the mixed particle dispersion liquid applied, thereby forming, on the substrate, the particle layer having a thickness of D that satisfies 0.5D≦Dc≦D.

2. The method according to claim 1, wherein the inorganic particle chains (A) and the inorganic particles (B) are composed of silica.

3. The method according to claim 1, wherein the particles (C) are composed of silica.

4. The method according to claim 1, which is a method for producing a layered article comprising a layer of particles stacked on a substrate, wherein a coagulant is further added in step (1).

5. The method according to claim 4, wherein the mixed particle dispersion liquid before the addition of the coagulant satisfies requirement (A) given below, and the mixed particle dispersion liquid after the addition of the coagulant satisfies requirement (B) given below:
Requirement (A): in a particle size distribution curve produced by measuring a mixed particle dispersion liquid by a laser diffraction scattering method, a particle diameter represented by the highest peak Ra is within the range of from 0.01 to 1 μm, and in a cumulative particle size distribution curve produced by measuring the mixed particle dispersion liquid by a laser diffraction scattering method, the particle diameter D90, at which the cumulative number of particles having particle diameters of D90 or less reaches 90% of the number of all particles, is 1 μm or less,
Requirement (B): in a particle size distribution curve produced by measuring a mixed particle dispersion liquid by a laser diffraction scattering method, there is a peak Rb which indicates a particle diameter equal to or larger than 20 times the particle diameter represented by the highest peak Ra.

6. The method according to claim 5, wherein the sum total of the volumes of particles having particle diameters equal to or larger than 20 times the particle diameter represented by the highest peak Ra is 1% or more of the total volume of the inorganic particle chains (A) and the inorganic particles (B) in the dispersion liquid after the addition of the coagulant.

7. The method according to claim 4, wherein the coagulant is a dehydrating agent.

8. The method according to claim 4, wherein the coagulant is an alcohol.

9. The method according to claim 4, wherein the average particle diameter of the particles (C) is greater than 60 nm and is not greater than the thickness of the layer of particles.

10. The method according to claim 4, wherein the inorganic particle chains (A) and the inorganic particles (B) are each composed of silica.

11. The method according to claim 4, wherein the particles (C) are composed of silica.
